(19) United States
(12) Patent Application Publication
(10) Pub. No.: US 2025/0260451 A1
(43) Pub. Date: Aug. 14, 2025

(54) Semi-Persistent Channel State Information (SP-CSI) Enhancement

(71) Applicant: Apple Inc., CUPERTINO, CA (US)

(72) Inventors: Haitong SUN, Saratoga, CA (US); Dawei ZHANG, Saratoga, CA (US); Ismael GUTIERREZ GONZALEZ, San Jose, CA (US); Louay JALLOUL, San Jose, CA (US); Yushu ZHANG, Beijing (CN)

(21) Appl. No.: 18/857,715

(22) PCT Filed: Apr. 25, 2022
(86) PCT No.: PCT/CN2022/089026

§ 371 Date: Oct. 17, 2024

(51) Int. Cl. H04B 7/06; H04W 24/10; H04W 72/0446

(52) U.S. Cl. CPC H04B 7/0626; H04W 24/10; H04W 72/0446

(57) ABSTRACT

A user equipment (UE) is configured to receive channel state information (CSI) report configuration information for reporting semi-persistent (SP)-CSI feedback, receive a signal configured to activate one or more configured sets of CSI reports, wherein the signal indicates a CSI report periodicity and slot offset to be utilized by the UE to report SP-CSI feedback, receive SP-CSI measurement resources for SP-CSI feedback and report the SP-CSI feedback to a network.

### TECHNICAL FIELD

The present disclosure generally relates to communication, and in particular, to the semi-persistent channel state information (SP-CSI) enhancement.

### BACKGROUND

A user equipment (UE) may connect to a fifth generation (5G) new radio (NR) network. In certain types of deployment scenarios, it has been identified that conventional channel state information (CSI) mechanisms may cause a UE with medium or high speed mobility to experience a significant performance loss. There is a need for semi-persistent (SP) CSI (SP-CSI) reporting enhancements configured to improve performance for a UE performance with medium or high speed mobility.

### SUMMARY

Some exemplary embodiments are related to a processor of a user equipment (UE) configured to perform operations. The operations include receiving channel state information (CSI) report configuration information for reporting semi-persistent (SP)-CSI feedback, receiving a signal configured to activate one or more configured sets of CSI reports, wherein the signal indicates a CSI report periodicity and slot offset to be utilized by the UE to report SP-CSI feedback, receiving SP-CSI measurement resources for SP-CSI feedback and reporting the SP-CSI feedback to a network.

Other exemplary embodiments are related to a user equipment (UE) having a transceiver configured to communicate with a base station and a processor communicatively coupled to the transceiver and configured to perform operations. The operations include receiving channel state information (CSI) report configuration information for reporting semi-persistent (SP)-CSI feedback, receiving a signal configured to activate one or more configured sets of CSI reports, wherein the signal indicates a CSI report periodicity and slot offset to be utilized by the UE to report SP-CSI feedback, receiving SP-CSI measurement resources for SP-CSI feedback and reporting the SP-CSI feedback to a network.

Still further exemplary embodiments are related to a processor of a base station configured to perform operations. The operations include transmitting channel state information (CSI) report configuration information for reporting semi-persistent (SP)-CSI feedback to a user equipment (UE), transmitting a signal configured to activate one or more configured sets of CSI reports at the UE, wherein the signal indicates a CSI report periodicity and slot offset to be utilized by the UE to report SP-CSI feedback and receiving the SP-CSI feedback from the UE.

Other exemplary embodiments are related to a base station having a transceiver configured to communicate with a user equipment (UE) and a processor communicatively coupled to the transceiver and configured to perform operations. The operations include transmitting channel state information (CSI) report configuration information for reporting semi-persistent (SP)-CSI feedback to a user equipment (UE), transmitting a signal configured to activate one or more configured sets of CSI reports at the UE, wherein the signal indicates a CSI report periodicity and slot offset to be utilized by the UE to report SP-CSI feedback and receiving the SP-CSI feedback from the UE.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows a signaling diagram for semi-persistent (SP)-channel state information (CSI) reporting according to various exemplary embodiments.

FIG. 5 shows examples of medium access control (MAC) control elements (CEs) that may be used for SP-CSI activation and deactivation according to various exemplary embodiments.

FIG. 6 shows a MAC CE that may be used to indicate the CSI report periodicity and offset according to various exemplary embodiments.

FIG. 7 shows a MAC CE that may be used to activate and deactivate SP-CSI resources for multiple serving cells according to various exemplary embodiments.

FIG. 8 shows a MAC CE that may be used to indicate a change in CSI report settings for SP-CSI reporting according to various exemplary embodiments.

FIG. 9 shows a MAC CE that may be used to indicate a change in CSI report settings for SP-CSI reporting according to various exemplary embodiments.

### DETAILED DESCRIPTION

The exemplary embodiments may be further understood with reference to the following description and the related appended drawings, wherein like elements are provided with the same reference numerals. The exemplary embodiments introduce channel state information (CSI) reporting enhancements related to semi-persistent (SP) CSI (SP-CSI) activation and deactivation.

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

The exemplary embodiments are also described with regard to a fifth generation (5G) New Radio (NR) network configured with type-II codebook based CSI feedback. However, reference to a 5G NR network is merely provided for illustrative purposes. The exemplary embodiments may be utilized with any network that utilizes SP-CSI.

In 5G NR, a type-II multiple input multiple output (MIMO) codebook may be based on a W₁* W₂* W_{F}, where W₁ represents a spatial basis selection, W_{f} represents a frequency basis selection and W₂ represents a combination coefficient. The type-II codebook may utilize the channel spatial domain properties W₁ and the frequency domain properties W_{f} to construct CSI efficiently. Specifically, the exemplary embodiments introduce CSI reporting enhancements related to SP-CSI activation and deactivation for 5G NR type-II codebook.

Under conventional circumstances, SP-CSI reporting periodicity may be configured semi-statically using radio resource control (RRC) signaling. For example, a “CSI-ReportConfig” information element (IE) may be included in an RRC message to provide a CSI report periodicity and offset parameter for SP-CSI reporting on the physical uplink control channel (PUCCH) or the physical uplink shared channel (PUSCH). The CSI report periodicity and offset may be characterized in slots or in any other appropriate manner. Subsequently, the network may selectively activate or deactivate SP-CSI resources at the UE 110.

A medium access control (MAC) control element (CE) may be used to activate and deactivate CSI reports. As will be described in more detail below, the exemplary embodiments introduce various techniques for utilizing a MAC CE configured to activate and deactivate CSI reports to additionally indicate a CSI report periodicity and, optionally offset. In other examples, downlink control information (DCI) may be used to activate and deactivate CSI reports. As will be described in more detail below, the exemplary embodiments introduce various techniques for utilizing DCI configured to activate and deactivate CSI reports to additionally indicate a CSI report periodicity and, optionally offset.

While the exemplary embodiments may provide performance benefits to a UE medium or high speed mobility, the exemplary embodiments are not limited to this type of deployment scenario and may be utilized by any appropriate UE. The exemplary enhancements introduced herein may be used independently from one another, in conjunction with currently implement CSI reporting mechanisms, in conjunction with future implementations of CSI reporting mechanisms or independently from other CSI reporting mechanisms.

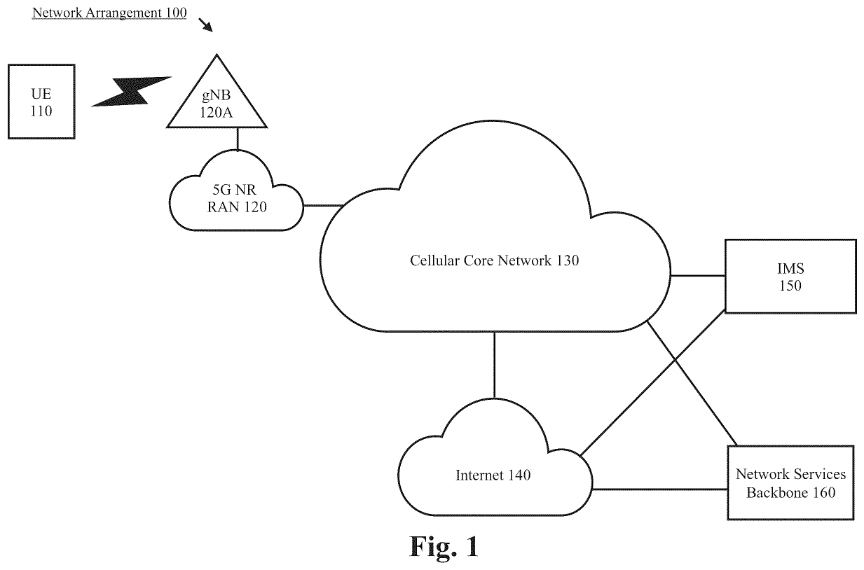

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be a portion of a cellular network that may be deployed by a network carrier (e. g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Those skilled in the art will understand that any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e. g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

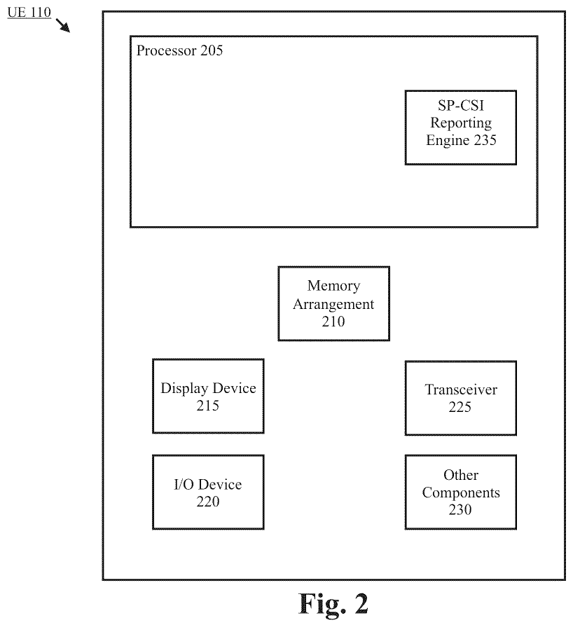

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a SP-CSI reporting engine 235. The SP-CSI reporting engine 235 may perform various operations related to SP-CSI including, but not limited to, receiving SP-CSI configuration information, receiving a MAC CE activating SP-CSI, receiving DCI activating SP-CSI, generating a CSI report and transmitting the CSI report to the network.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

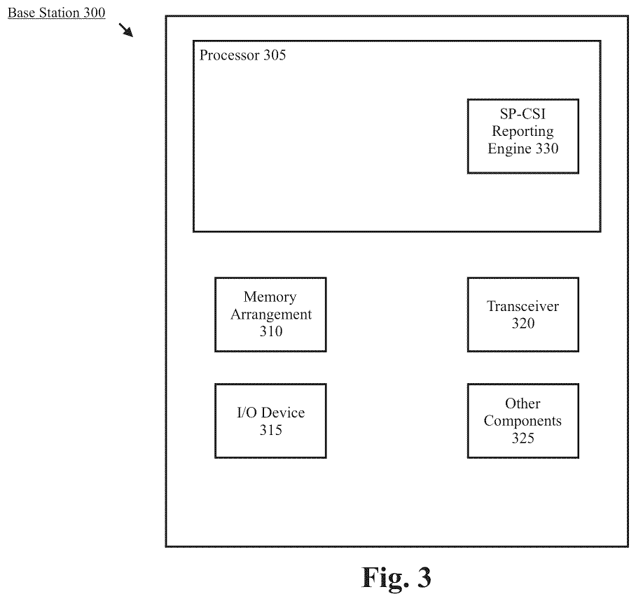

FIG. 3 shows an exemplary base station 300 according to various exemplary embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320 and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the base station 300. For example, the engines may include a SP-CSI reporting engine 330. The SP-CSI reporting engine 330 may perform various operations related to SP-CSI including, but not limited to, transmitting SP-CSI configuration information, transmitting a MAC CE activating SP-CSI, transmitting DCI activating SP-CSI and receiving a CSI report.

The above noted engine 330 being an application (e. g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs.

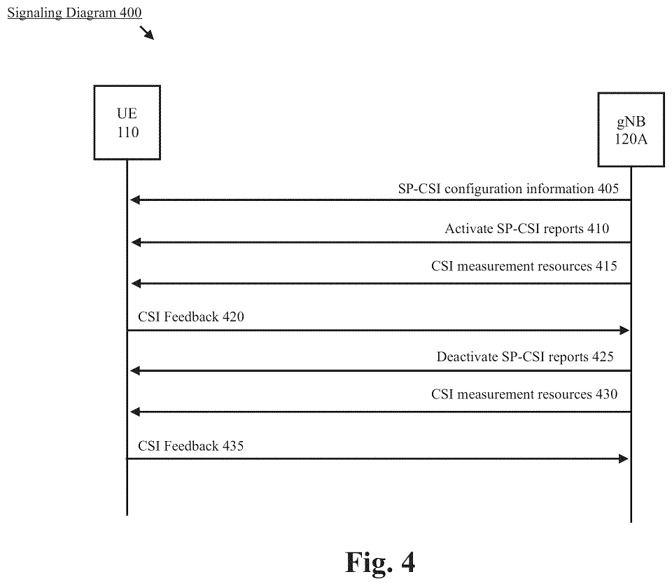

FIG. 4 shows a signaling diagram 400 for SP-CSI reporting according to various exemplary embodiments. The signaling diagram 400 is described with regard to the network arrangement 100 of FIG. 1, the UE 110 of FIG. 2 and the base station 300 of FIG. 3.

The signaling diagram 400 includes the UE 110 and the qNB 120A. In 405, the UE 110 receives SP-CSI configuration information from the qNB 120A. The SP-CSI configuration information may be provided to the UE 110 in one or more RRC messages. For example, the a “CSI-ReportConfig” IE in an RRC message may be utilized. However, the exemplary embodiments are not limited to any particular type of RRC message, the network may provide the UE 110 with SP-CSI report configuration information in any appropriate type of message (e.g., RRC, MAC CE, DCI, etc.)

The SP-CSI configuration information may include configuration information for CSI measurement resources, CSI resources may include channel measurement resources (CMR) and interference measurement resources (IMR). The CMRs may include one or more non-zero power (NZP) CSI-reference signals (RS). The periodicity and offset of these CMRs resources may be characterized in slots or in any other appropriate manner. Throughout this description, any reference to a particular type of CMR is merely provided for illustrative purposes, the exemplary embodiments may apply to any appropriate type of CMR.

The IMRs may include one or more zero power (ZP)-CSI-RS, NZP-CSI-RS or a combination thereof. Throughout this description, the terms “ZP IMR” and “CSI-IM” may be used interchangeably to identify the same type of CSI resources and “IMR” may refer to “ZP IMR,” “NZP IMR” or a combination of “ZP IMR” and “NZP IMR.” The periodicity and offset of these IMRs may be characterized in slots or in any other appropriate manner. Throughout this description, any reference to a particular type of IMR is merely provided for illustrative purposes, the exemplary embodiments may apply to any appropriate type of IMR.

The UE 110 may be configured with one or more sets of CSI measurement resources. Each set of CSI measurement resources may include one or more CMRs and/or one or more IMRs. The network may configure the sets of CSI measurement resources using the CSI report configuration information in 405 or any other appropriate message. Once configured, the network may activate or deactivate a set of CSI measurement resources and/or CSI reports at the UE 110.

In 410, the UE 110 receives a message to activate one or more sets of SP-CSI reports. In some embodiments, a MAC CE may be used to activate one or more sets of SP-CSI reports. In other embodiments, DCI may be used to activate one or more sets of SP-CSI reports.

To provide an example from the perspective of the UE 110, consider a scenario in which multiple sets of CSI reports have been configured by the network. Initially, a first set of SP-CSI reports (SP-CSI-1), a second set of SP-CSI reports (SP-CSI-2) and a third set of SP-CSI reports (SP-CSI-3) are configured and in a deactivated state. When in the deactivated state, the UE 110 may not monitor for and/or attempt to measure the corresponding CSI measurement resources. Subsequently, the network may send the message in 410 to activate one or more sets of configured SP-CSI reports at the UE 110. For example, the message may indicate that SP-CSI-1, SP-CSI-2 and/or SP-CSI-3 have been activated. When in the activated state, the UE 110 may monitor and attempt to measure the corresponding CSI measurement resources. Thus, if the network activates SP-CSI-1 and SP-CSI-3, the UE 110 may attempt to monitor and measure SP-CSI-1 and SP-CSI-3. However, the UE 110 may continue to refrain from monitoring for and attempting to measure SP-CSI-2 due to the deactivated state.

Under conventional circumstances, a CSI report periodicity and offset for SP-CSI reporting on the physical uplink control channel (PUCCH) or the physical uplink shared channel (PUSCH) may be provided in an RRC message. As will be described in more detail below, the exemplary embodiments introduce various techniques for utilizing a MAC CE to activate/deactivate SP-CSI reports and indicate a CSI report periodicity and, optionally, offset for one or more sets of SP-CSI reports. In addition, the exemplary embodiments also introduce various techniques for utilizing DCI to activate/deactivate SP-CSI reports and indicate a CSI report periodicity and, optionally, offset for one or more sets of SP-CSI reports. Specific examples of each of the exemplary techniques will be provided below after the description of 415-435 of the signaling diagram 400.

In 415, the UE 110 receives CSI measurement resources. In the signaling diagram 400, the CSI measurement resources are transmitted by the qNB 120A. However, in an actual deployment scenario, the UE 110 may receive CSI measurement resources from multiple serving cells including serving cells deployed by a gNB or base station other than the gNB 120A. Therefore, the message in 420 may be sent by a cell of a first base station but include information for other serving cells of the first base station and/or a serving cell of a second different base station.

In 420, the UE 110 transmits CSI feedback to the qNB 120A. The CSI feedback may include measurement data corresponding to the measurement resources configured in one or more activated sets of SP-CSI reports. The timing of the CSI feedback may be based on a CSI report periodicity and optionally, offset indicated by a message configured to activate one or more sets of SP-CSI reports (e.g., 410). Continuing with the example provided above, if SP-CSI-1 and SP-CSI-3 are activated in 410 and SP-CSI-2 is still deactivated, the CSI feedback may include measurement data corresponding to SP-CSI-1 and/or SP-CSI-3 but may not include measurement data corresponding to SP-CSI-2 because the UE 110 did not monitor for or measure SP-CSI-2 due to its deactivated state.

In 425, the UE 110 receives a message to deactivate one or more sets of SP-CSI reports. In this example, at least one set of SP-CSI reports that were previously activated are deactivated in this message, e.g., SP-CSI-1 or SP-CSI-3. In some embodiments, a MAC CE may be used to deactivate one or more CSI reports. In other embodiments, DCI may be used to deactivate CSI reports.

In 430, the UE 110 receives CSI measurement resources. In this example, it may be assumed that SP-CSI-1 was deactivated in the message received in 425. Thus, the UE 110 may monitor for and attempt to measure activated SP-CSI reports (e.g., SP-CSI-3) and may not measure any deactivated SP-CSI reports (e.g., SP-CSI-1 and SP-CSI-2) .

In 435, the UE 110 transmits CSI feedback to the qNB 120A. As mentioned above, the CSI feedback may include measurement data corresponding to one or more activated sets of SP-CSI reports. However, in this example, the CSI feedback in 420 and the CSI feedback in 435 may not contain measurement data corresponding to the same SP-CSI measurement reports because at least one set of SP-CSI reports were deactivated in 425. Continuing with the example provided above, if SP-CSI-1 is deactivated in 425 and SP-CSI-3 is still activated, the CSI feedback may include measurement data corresponding to SP-CSI-3 but may not include measurement data corresponding to SP-CSI-1 or SP-CSI-2 because the UE 110 did not monitor for or measure SP-CSI-1 or SP-CSI-2 due to their respective deactivated states.

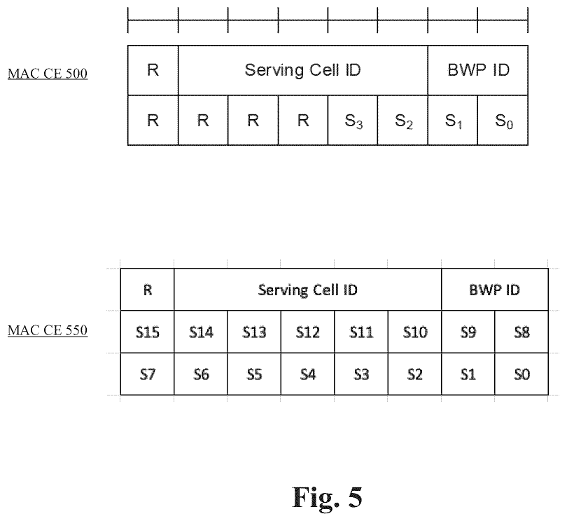

FIG. 5 shows examples of MAC CEs that may be used for SP-CSI activation and deactivation according to various exemplary embodiments. Those skilled in the art will understand that a MAC CE may be provided as part of a MAC protocol data unit (PDU) and used for MAC layer signaling between the UE 110 and a cell of the network.

In this example, the MAC CE 500 includes a serving cell ID field comprising of one or more bits to indicate the identity of the serving cell for which the MAC CE applies. In addition, the MAC CE 500 may include a bandwidth part (BWP) ID field comprising one or more bits to indicate an identity of a BWP for which the MAC CE applies. In addition, the MAC CE 500 may include one or more reserved bits “R.”

The MAC CE 500 may include multiple fields for SP-CSI activation and deactivation. Each “Sᵢ” field may comprise one or more bits to indicate an activation state (e.g., activated or deactivated) for a set of configured SP-CSI reports. For example, when a bit of an “Sᵢ” field is set to a first value (e.g., 1), this may indicate that the corresponding set of SP-CSI reports are activated. When the bit of an “Sᵢ” field is set to a second value (e.g., 0), this may indicate that the corresponding set of SP-CSI reports are deactivated.

Within the MACE CE, the Sᵢ fields may be ordered based on the ID of the corresponding CSI-ReportConfig IE (e.g., CSI-ReportConfigId) or on any other appropriate basis. In this example, the MAC CE 500 shows four Sᵢ fields (S1, S2, S3, S4) and thus, the MAC CE 500 may be used to indicate the activation state for four different sets of SP-CSI reports, However, the exemplary embodiments are not limited to a MAC CE configured with four Sᵢ fields and any appropriate number of Sᵢ fields may be utilized. For instance, the MAC CE 550 is configured with 16 “S” fields, e.g., S0-S15. Therefore, the MAC CE 550 may be used to indicate the activation state for 16 different sets of SP-CSI reports.

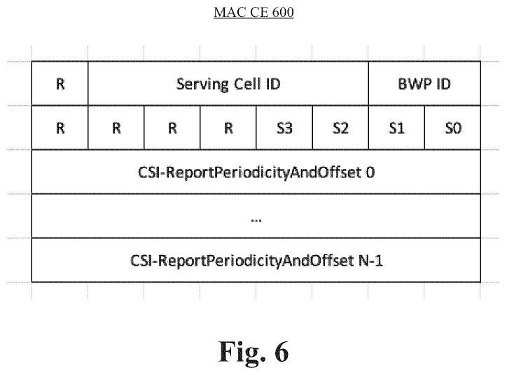

The exemplary embodiments introduce a new field for a MAC CE to indicate the CSI report periodicity and, optionally, slot offset for an activated SP-CSI reports. FIG. 6 shows a MAC CE 600 that may be used to indicate the CSI report periodicity and offset according to various exemplary embodiments.

The MAC CE 600 includes a serving cell ID field comprising of one or more bits to indicate the identity of the serving cell for which the MAC CE applies. In addition, the MAC CE 600 may include a BWP ID field comprising one or more bits to indicate an identity of a BWP for which the MAC CE applies. The MAC CE 600 may include one or more reserved bits “R.” The MAC CE 600 may include multiple fields for SP-CSI activation and deactivation. Each “Sᵢ” field may comprise one or more bits to indicate an activation state (e.g., activated or deactivated) for a set of configured SP-CSI reports.

In addition, the MAC CE 600 may include multiple fields each comprising one or more bits configured to indicate CSI report periodicity and offset parameters, e.g., “CSI-ReportPeriodicityAndOffset.” In this example, each instance of CSI-ReportPeriodicityAndOffset may indicate a periodicity and/or slot offset for an activated set of SP-CSI reports. There may be a one-to-one mapping between the set of CSI reports indicated by an Sᵢ field and the CSI report periodicity and offset parameters indicated by a CSI-ReportPeriodicityAndOffset field. In some embodiments, the number of CSI-ReportPeriodicityAndOffset fields may be based on the number of Sᵢ fields. In other embodiments, the number of CSI-ReportPeriodicityAndOffset fields may be based on the number of activated sets of SP-CSI reports. Thus, the (N) value of the index shown in the MAC CE 600 for the CSI-ReportPeriodicityAndOffset fields may represent a number Sᵢ fields or a number of sets of activated SP-CSI reports.

In the MAC CE 600, each CSI-ReportPeriodicityAndOffset field may include multiple sets of periodicity and slot offset values that may be utilized by the UE 110 to report CSI for the corresponding SP-CSI reports. Alternatively, the CSI report configuration information provided in 405 may include a list of multiple different periodicity and slot offset values that may be utilized by the UE 110 to report CSI for the corresponding SP-CSI reports. For example, this list may be provided in CSI-ReportConfig IE of an RRC message. With this approach, the CSI-ReportPeriodicityAndOffset field of the MAC CE 600 may include a value that indicates which periodicity and slot offset values from the previously provided list are to be utilized by the UE 110 to report CSI for the corresponding SP-CSI reports. To provide an example, the list may include 16 different sets of values. A CSI-ReportPeriodicityAndOffset field of at least four bits (e.g., 0000, 0001, 0101, 1111, etc.) may be used to indicate which set of values from the 16 different entries is to be used by the UE 110 to report CSI for the corresponding SP-CSI reports.

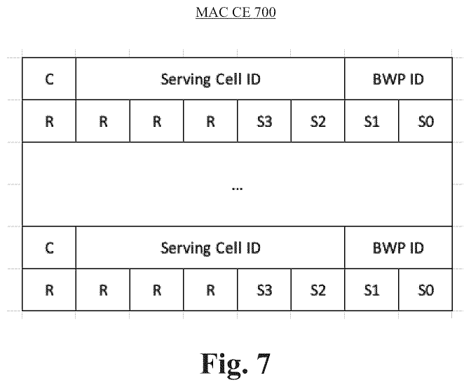

To reduce overhead and improve latency, a single MAC CE may be used to activate/deactivate SP-CSI in multiple different serving cells. FIG. 7 shows a MAC CE 700 that may be used to activate and deactivate SP-CSI resources for multiple serving cells according to various exemplary embodiments. The MAC CE 700 includes multiple serving cell ID fields each comprising of one or more bits to indicate the identity of the serving cells for which the MAC CE applies. In addition, the MAC CE 700 may include multiple BWP ID fields. Each BWP ID field is associated with a serving cell ID and comprises one or more bits to indicate an identity of a BWP for which the MAC CE applies. The MAC CE 700 may include one or more reserved bits “R.” The MAC CE 700 may include, for each serving cell ID field, multiple fields for SP-CSI activation and deactivation. Each “Sᵢ” field may comprise one or more bits to indicate an activation state (e.g., activated or deactivated) for a set of configured SP-CSI reports.

In addition, for each serving cell ID field, a “C” field may be used to indicate whether there is a next serving cell ID field in the frequency domain for this MAC CE. When the C field is set to a first value (e.g., 1), this may indicate that the MAC CE will include another next serving cell ID field in the frequency domain. When the C field is set to a second value (e.g., 0), this may indicate that the MAC CE will not include another next serving cell ID field in the frequency domain. In this example, the first C field 710 may be set to the first value to indicate the presence of a next serving cell ID field in this MAC CE and the second C field 715 may be set to the second value to indicate that the corresponding service cell ID field is the last serving cell ID field of this MAC CE.

As mentioned above, in some embodiments, DCI may be used to activate and deactivate SP-CSI reports. The DCI may be scrambled using a radio network temporary identifier (RNTI) configured to activate SP-CSI reporting on the physical uplink shared channel (PUSCH), e.g., SP-CSI-RNTI, Those skilled in the art will understand that the SP-CSI-RNTI is a UE unique identifier.

The network may change the CSI reporting and slot offset for a set of SP-CSI reports by transmitting DCI scrambled with SP-CSI-RNTI. To provide an example, the UE 110 may be configured with a first set of SP-CSI reports in an activated state (SP-CSI-1) . When SP-CSI-1 is activated or was previously activated, the UE 110 may receive DCI scrambled with SP-CSI-RNTI configured to activate SP-CSI-1 reports. This activation may be used to change the CSI report periodicity and/or slot offset for SP-CSI-1.

In some embodiments, to indicate the CSI report periodicity and offset, a new field may be introduced to DCI that is configured to indicate the CSI report periodicity and offset for the corresponding SP-CSI reports. In other embodiments to indicate the CSI report periodicity and offset, the time domain resource assignment (TDRA) may be utilized. To provide an example, a list of different sets of CSI report periodicity and offset values may be configured at the UE 110 for a set of SP-CSI reports via RRC signaling. The list of different sets of CSI report periodicity and offset values may be mapped to the different TDRA values. For instance, the list of different sets of CSI report periodicity and offset values may include a number of entries that is equal to the number of entries of the TDRA table. The TDRA table may also be configured via RRC signaling (e.g., pusch-TimeDomain AllocationList in PUSCH-Config IE). In this example, there may be a one-to-one mapping between one entry of the TDRA table and one entry from the list of different sets of CSI report periodicity and offset values. When an entry from the TDRA table is indicated in the TDRA field of the DCI, it may indicate its intended purpose (e. g., TDRA) and which CSI report periodicity and offset values are to be utilized by the UE 110 based on the mapping to between TDRA table and the list of CSI report periodicity and offset values. However, reference to a one-to-one mapping is provided for illustrative purposes, the exemplary embodiments may utilize any appropriate type of mapping between TDRA values signaled in DCI and CSI report periodicity and offset values.

In addition, the exemplary MAC CE and/or DCI described herein may be enhanced to indicate a configuration change for one or more IEs included in the CSI-ReportConfig IE of an RRC message. These IEs may include, but are not limited to, “resourceForChannelMeasurement” which is related to the configuration of CMR resources, “csi-IM-ResourcesForInterference” which is related to ZP IMR resources, “reportQuantity” which is related to the CSI related quantities to report, “nzp-CSI-RS-ResourceForInterference” which is related to NZP IMR resources, “reportFreqConfiguration” which is related to the report frequency domain configuration, “timeRestrictionForChannelMeasurements” and “timeRestrictionFor InterferenceMeasurements” which relate to report time domain configuration, “codebookConfig” which related to a codebook type and “subbandSize” which related to a size of subband.

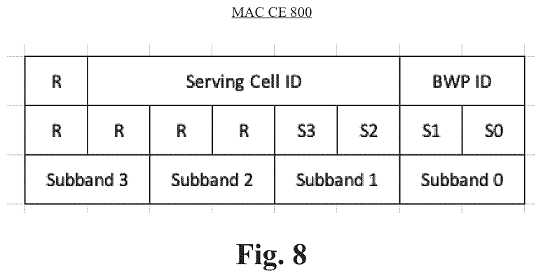

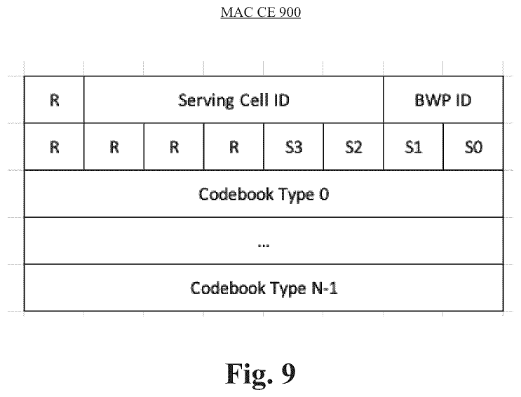

The MAC CEs shown in FIGS. 8-9 provide examples of how a MAC CE may be used to indicate a configuration change corresponding to a parameter provided in a CSI-ReportConfig IE of an RRC message. The MAC CE 800 of FIG. 8 shows an example of indicating a subband configuration change (e.g., subbandSize IE). Those skilled in the art will understand that the exemplary techniques described below with regard to the MAC CE 800 may be utilized for any of the other IEs referenced above. Similarly, the MAC CE 900 of FIG. 9 shows an example of indicating a codebook configuration change (e.g., codebookConfig IE). Those skilled in the art will understand that the exemplary techniques described below with regard to the MAC CE 900 may be utilized for any of the other IEs referenced above. In addition, similar types of fields may be added to DCI to indicate a configuration change corresponding to a parameter provided in a CSI-ReportConfig IE of an RRC message,

FIG. 8 shows a MAC CE 800 that may be used to indicate a change in CSI report settings for SP-CSI reporting according to various exemplary embodiments. The MAC CE 800 includes one or more serving cell ID fields each comprised of one or more bits to indicate the identity of a serving cell for which the MAC CE applies. In addition, the MAC CE 800 may include one or more BWP ID fields. Each BWP ID field is associated with a serving cell ID and comprises one or more bits to indicate an identity of a BWP for which the MAC CE applies. The MAC CE 800 may also include one or more reserved bits “R.” In addition, the MAC CE 800 may include, for each serving cell ID field, multiple fields for SP-CSI activation and deactivation. Each “Sᵢ” field may comprise one or more bits to indicate an activation state (e.g., activated or deactivated) for a set of configured SP-CSI reports.

The MAC CE 800 may also include one or more subband fields. Each subband field may include one or more bits configured to indicate one or more different configurations for each SP-CSI. When a subband field is set to a first value (e.g., 1), this may indicate that a first subband configuration is to be utilized by the UE 110. When a subband field is set to a second value (e.g., 0), this may indicate that a second different subband configuration is to be utilized. Thus, a single bit may be used to toggle between two different subband configurations. In addition, another bit in a subband field may be used to indicate whether precoding matrix indicator (PMI) subband needs to be oversampled compared to channel quality indicator (CQI) subband,

The exemplary techniques described above demonstrate how a MAC CE may be used to indicate a configuration change corresponding to a parameter provided in a CSI-ReportConfig IE of an RRC message. Instead of or in addition to the subband fields, one or more fields associated with other CSI report configuration parameters may use a similar toggle mechanism to indicate a change between multiple different configurations. For example, the configuration of IEs such as, but not limited to, “resourceForChannelMeasurement” which is related to the configuration of CMR resources, “csi-IM-ResourcesForInterference” which is related to ZP IMR resources, “reportQuantity” which is related to the CSI related quantities to report, “nzp-CSI-RS-ResourceForInterference” which is related to NZP IMR resources, “reportFreqConfiguration” which is related to the report frequency domain configuration, “timeRestrictionForChannelMeasurements” and “timeRestrictionForInterferecneMeasurements” which relate to report time domain configuration and “codebookConfig” which is related to a codebook type may also use be changed with a MAC CE using the toggle mechanism described above.

FIG. 9 shows a MAC CE 900 that may be used to indicate a change in CSI report settings for SP-CSI reporting according to various exemplary embodiments. The MAC CE 900 includes one or more serving cell ID fields each comprised of one or more bits to indicate the identity of a serving cell for which the MAC CE applies. In addition, the MAC CE 900 may include one or more BWP ID fields. Each BWP ID field is associated with a serving cell ID and comprises one or more bits to indicate an identity of a BWP for which the MAC CE applies. The MAC CE 900 may also include one or more reserved bits “R.” In addition, the MAC CE 900 may include, for each serving cell ID field, multiple fields for SP-CSI activation and deactivation. Each “Sᵢ” field may comprise one or more bits to indicate an activation state (e.g., activated or deactivated) for a set of configured SP-CSI reports.

The MAC CE 900 may also include a codebook type field comprising one or more bits configured to indicate a codebook type configuration for each set of SP-CSI reports. The CSI report configuration information provided in 405 may include a list of multiple different codebook types that may be utilized by the UE 110 to report CSI for the corresponding SP-CSI reports. For example, this list may be provided in CSI-ReportConfig IE of an RRC message. With this approach, the codebook type field of the MAC CE 900 may include a value that indicates which codebook configuration (e.g., codebookConfig) is to be utilized by the UE 110 to report CSI for the corresponding SP-CSI reports.

The exemplary techniques described above demonstrate how a MAC CE may be used to indicate a configuration change corresponding to a parameter provided in a CSI-ReportConfig IE of an RRC message. Instead of or in addition to the codebook type fields, one or more fields associated with other CSI report configuration parameters may use a similar mechanism to indicate a change between multiple different configurations corresponding to a particular the SP-CSI reports of an Sᵢ field. For example, the configuration of IEs such as, but not limited to, “resourceForChannelMeasurement” which is related to the configuration of CMR resources, “csi-IM-ResourcesForInterference” which is related to ZP IMR resources, “reportQuantity” which is related to the CSI related quantities to report, “nzp-CSI-RS-ResourceForInterference” which is related to NZP IMR resources, “reportFreqConfiguration” which is related to the report frequency domain configuration, “timeRestrictionForChannelMeasurements” and “timeRestrictionForInterferecneMeasurements” which relate to report time domain configuration, “codebookConfig” which related to a codebook type and “subbandSize” which related to a size of subband may also be changed with a MAC CE using the mechanism described above.

### EXAMPLES

In a first example, a method performed by a user equipment (UE), comprising receiving channel state information (CSI) report configuration information for reporting semi-persistent (SP)-CSI feedback, receiving a signal configured to activate one or more configured sets of CSI reports, wherein the signal indicates a CSI report periodicity and slot offset to be utilized by the UE to report SP-CSI feedback, receiving SP-CSI measurement resources for SP-CSI feedback and reporting the SP-CSI feedback to a network.

In a second example, the method of the first example, wherein the signal is a medium access control (MAC) control element (CE).

In a third example, the method of the second example, wherein the MAC CE includes a serving cell ID field configured indicate a serving cell ID for which the MAC CE applies and multiple fields associated with the serving cell ID field that are each configured to indicate an activation state for a corresponding SP-CSI report.

In a fourth example, the method of the third example, wherein the multiple fields are ordered within the MAC CE based on the ID of a corresponding CSI-ReportConfig information element (IE) provided as part of the CSI report configuration information.

In a fifth example, the method of the third example, wherein the MAC CE further comprises one or more CSI report periodicity and offset fields, each CSI report periodicity and offset field corresponding to a different set of SP-CSI reports and configured to indicate a CSI report periodicity and offset.

In a sixth example, the method of the fifth example, wherein a number of CSI report periodicity and offset fields included in the MAC CE is based on a number of activated SP-CSI reports.

In a seventh example, the method of the fifth example, wherein each CSI report periodicity and offset field includes a value indicating that an entry from a list of CSI report periodicity and offset values provided as part of the CSI report configuration information is to be utilized by the UE.

In an eighth example, the method of the third example, wherein the MAC CE is configured to activate and deactivate SP-CSI reports for multiple serving cells.

In a ninth example, the method of the third example, wherein the MAC CE is further configured to indicate a configuration change corresponding to an information element (IE) provided as part of a CSI-ReportConfig in the CSI report configuration information.

In a tenth example, the method of the ninth example, wherein the IE is one of, resourcesForChannelMeasurement, csi-IM-ResoucresForInterference, reportQuality, nzp-CSI-RS-ResoucresForInterference, report FreqConfig, timeRestrictionForChannelMeasurements, imeRestrictionForInterferenceMeasurements, codebookConfig or subbandSize.

In an eleventh example, the method of the first example, wherein the signal is downlink control information (DCI).

In a twelfth example, the method of the eleventh example, wherein the DCI is scrambled with a SP-CSI-radio network temporary identifier (RNTI).

In a thirteenth example, the method of the eleventh example, wherein the DCI includes a field configured to indicate a CSI report periodicity and slot offset for SP-CSI reports.

In a fourteenth example, the method of the eleventh example, wherein the DCI includes a time domain resource allocation (TDRA) value, wherein the TDRA value is mapped to an entry of a list comprising sets of CSI report periodicity and slot offset values.

In a fifteenth example, the method of the fourteenth example, wherein the list is provided in the CSI report configuration information.

In a sixteenth example, the method of the eleventh example, wherein the DCI is further configured to indicate a configuration change corresponding to an information element (IE) provided as part of a CSI-ReportConfig in the CSI report configuration information.

In a seventeenth example, the method of the sixteenth example, wherein the IE is one of, resourcesForChannelMeasurement, csi-IM-ResoucresFor Interference, reportQuality, nzp-CSI-RS-ResoucresForInterference, reportFreqConfig, timeRestrictionForChannelMeasurements, imeRestrictionForInterferenceMeasurements, codebookConfig or subbandSize.

In an eighteenth example, a processor of a user equipment (UE) configured to perform any of the operations of the first through seventeenth examples.

In a nineteenth example, a user equipment (UE) comprising a transceiver configured to communicate with a base station and a processor communicatively coupled to the transceiver and configured to perform any of the operations of the first through seventeenth examples.

In a twentieth example, a method is performed by a base station, comprising transmitting channel state information (CSI) report configuration information for reporting semi-persistent (SP)-CSI feedback to a user equipment (UE), transmitting a signal configured to activate one or more configured sets of CSI reports at the UE, wherein the signal indicates a CSI report periodicity and slot offset to be utilized by the UE to report SP-CSI feedback and receiving the SP-CSI feedback from the UE.

In a twenty first example, the method of the twentieth example, wherein the signal is a medium access control (MAC) control element (CE).

In a twenty second example, the method of the twenty first example, wherein the MAC CE includes a serving cell ID field configured indicate a serving cell ID for which the MAC CE applies and multiple fields associated with the serving cell ID field that are each configured to indicate an activation state for of a corresponding SP-CSI report.

In a twenty third example, the method of the twenty second example, wherein the multiple fields are ordered within the MAC CE based on the ID of a corresponding CSI-ReportConfig information element (IE) provided as part of the CSI report configuration information.

In a twenty fourth example, the method of the twenty second example, wherein the MAC CE further comprises one or more CSI report periodicity and offset fields, each CSI report periodicity and offset field corresponding to a different set of SP-CSI reports and configured to indicate a CSI report periodicity and offset.

In a twenty fifth example, the method of the twenty fourth example, wherein a number of CSI report periodicity and offset fields included in the MAC CE is based on a number of activated SP-CSI reports.

In a twenty sixth example, the method of the twenty fourth example, wherein each CSI report periodicity and offset field includes a value indicating that an entry from a list of CSI report periodicity and offset values provided as part of the CSI report configuration information is to be utilized by the UE.

In a twenty seventh example, the method of the twenty second example, wherein the MAC CE is configured to activate and deactivate SP-CSI reports for multiple serving cells.

In a twenty eighth example, the method of the twenty second example, wherein the MAC CE is further configured to indicate a configuration change corresponding to an information element (IE) provided as part of a CSI-ReportConfig in the CSI report configuration information.

In a twenty ninth example, the method of the twenty eighth example, wherein the IE is one of, resources ForChannelMeasurement, csi-IM-ResoucresFor Interference, reportQuality, nzp-CSI-RS-ResoucresForInterference, reportFreqConfig, timeRestrictionForChannelMeasurements, imeRestrictionFor InterferenceMeasurements, codebookConfig or subbandSize.

In a thirtieth example, the method of the twentieth example, wherein the signal is downlink control information (DCI).

In a thirty first example, the method of the thirtieth example, wherein the DCI is scrambled with a SP-CSI-radio network temporary identifier (RNTI).

In a thirty second example, the method of the thirtieth example, wherein the DCI includes a field configured to indicate a CSI report periodicity and slot offset for SP-CSI reports.

In a thirty third example, the method of the thirtieth example, wherein the DCI includes a time domain resource allocation (TDRA) value, wherein the TDRA value is mapped to an entry of a list comprising sets of CSI report periodicity and slot offset values.

In a thirty fourth example, the method of the thirty third example, wherein the list is provided in the CSI report configuration information.

In a thirty fifth example, the method of the thirtieth example, wherein the DCI is further configured to indicate a configuration change corresponding to an information element (IE) provided as part of a CSI-ReportConfig in the CSI report configuration information.

In a thirty sixth example, the method of the thirty fifth example, wherein the IE is one of, resourcesForChannelMeasurement, csi-IM-ResourcesForInterference, reportQuality, nzp-CSI-RS-ResoucresForInterference, reportFreqConfig, timeRestrictionForChannelMeasurements, imeRestrictionForInterferenceMeasurements, codebookConfig or subbandSize.

In a thirty seventh example, a processor of a base station configured to perform any of the operations of the twentieth through thirty sixth examples.

In a thirty eighth example, a base station comprising a transceiver configured to communicate with a user equipment (UE) and a processor communicatively coupled to the transceiver and configured to perform any of the operations of the twentieth through thirty sixth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A processor of a user equipment (UE) configured to perform operations comprising:
receiving channel state information (CSI) report configuration information for reporting semi-persistent (SP)-CSI feedback;
receiving a signal configured to activate one or more configured sets of CSI reports, wherein the signal indicates a CSI report periodicity and slot offset to be utilized by the UE to report SP-CSI feedback;
receiving SP-CSI measurement resources for SP-CSI feedback; and
reporting the SP-CSI feedback to a network.

2. The processor of claim 1, wherein the signal is a medium access control (MAC) control element (CE) and wherein the MAC CE includes a serving cell ID field configured indicate a serving cell ID for which the MAC CE applies and multiple fields associated with the serving cell ID field that are each configured to indicate an activation state for a corresponding SP-CSI report.

3. The processor of claim 2, wherein the multiple fields are ordered within the MAC CE based on the ID of a corresponding CSI-ReportConfig information element (IE) provided as part of the CSI report configuration information.

4. The processor of claim 2, wherein the MAC CE further comprises one or more CSI report periodicity and offset fields, each CSI report periodicity and offset field corresponding to a different set of SP-CSI reports and configured to indicate a CSI report periodicity and offset.

5. The processor of claim 2, wherein the MAC CE is configured to activate and deactivate SP-CSI reports for multiple serving cells.

6. The processor of claim 2, wherein the MAC CE is further configured to indicate a configuration change corresponding to an information element (IE) provided as part of a CSI-ReportConfig in the CSI report configuration information.

7. The processor of claim 1, wherein the signal is downlink control information (DCI) and wherein the DCI is scrambled with a SP-CSI-radio network temporary identifier (RNTI).

8. The processor of claim 1, wherein the signal is downlink control information (DCI) and wherein the DCI includes a field configured to indicate a CSI report periodicity and slot offset for SP-CSI reports.

9. The processor of claim 1, wherein the signal is downlink control information (DCI) and wherein the DCI includes a time domain resource allocation (TDRA) value, wherein the TDRA value is mapped to an entry of a list comprising sets of CSI report periodicity and slot offset values.

10. The processor of claim 1, wherein the signal is downlink control information (DCI) and wherein the DCI is further configured to indicate a configuration change corresponding to an information element (IE) provided as part of a CSI-ReportConfig in the CSI report configuration information.

11. A processor of a base station configured to perform operations comprising:
transmitting channel state information (CSI) report configuration information for reporting semi-persistent (SP)-CSI feedback to a user equipment (UE);
transmitting a signal configured to activate one or more configured sets of CSI reports at the UE, wherein the signal indicates a CSI report periodicity and slot offset to be utilized by the UE to report SP-CSI feedback; and
receiving the SP-CSI feedback from the UE.

12. The processor of claim 11, wherein the signal is a medium access control (MAC) control element (CE) and, wherein the MAC CE includes a serving cell ID field configured indicate a serving cell ID for which the MAC CE applies and multiple fields associated with the serving cell ID field that are each configured to indicate an activation state for of a corresponding SP-CSI report.

13. The processor of claim 12, wherein the multiple fields are ordered within the MAC CE based on the ID of a corresponding CSI-ReportConfig information element (IE) provided as part of the CSI report configuration information.

14. The processor of claim 12, wherein the MAC CE further comprises one or more CSI report periodicity and offset fields, each CSI report periodicity and offset field corresponding to a different set of SP-CSI reports and configured to indicate a CSI report periodicity and offset.

15. The processor of claim 12, wherein the MAC CE is configured to activate and deactivate SP-CSI reports for multiple serving cells.

16. The processor of claim 12, wherein the MAC CE is further configured to indicate a configuration change corresponding to an information element (IE) provided as part of a CSI-ReportConfig in the CSI report configuration information.

17. The processor of claim 11, wherein the signal is downlink control information (DCI) and wherein the DCI is scrambled with a SP-CSI-radio network temporary identifier (RNTI).

18. The processor of claim 11, wherein the signal is downlink control information (DCI) and the DCI includes a field configured to indicate a CSI report periodicity and slot offset for SP-CSI reports.

19. The processor of claim 11, wherein the signal is downlink control information (DCI) and the DCI includes a time domain resource allocation (TDRA) value, wherein the TDRA value is mapped to an entry of a list comprising sets of CSI report periodicity and slot offset values.

20. The processor of claim 11, wherein the signal is downlink control information (DCI) and the DCI is further configured to indicate a configuration change corresponding to an information element (IE) provided as part of a CSI-ReportConfig in the CSI report configuration information.
